(19) United States
(12) Patent Application Publication
(10) Pub. No.: US 2013/0110748 A1
(43) Pub. Date: May 2, 2013

(54) Policy Violation Checker

(71) Applicants: Mayank TALATI, Hyderabad (IN); Dan BELOV, San Francisco, CA (US); Gary YOUNG, Mountain View, CA (US); Ashley VESELKA, San Francisco, CA (US)

(72) Inventors: Mayank TALATI, Hyderabad (IN); Dan BELOV, San Francisco, CA (US); Gary YOUNG, Mountain View, CA (US); Ashley VESELKA, San Francisco, CA (US)

(73) Assignee: Google Inc., Mountain View, CA (US)

(21) Appl. No.: 13/599,731

(22) Filed: Aug. 30, 2012

(30) Foreign Application Priority Data
Aug. 30, 2011 (IN) 2996/CHE/2011

(51) Int. Cl. G06F 17/30; G06N 99/00

(52) U.S. Cl. CPC G06F 17/30985; G06N 99/005
USPC 706/12; 707/758

(57) ABSTRACT

Methods and systems for identifying problematic phrases in an electronic document, such as an e-mail, are disclosed. A context of an electronic document may be detected. A textual phrase entered by a user is captured. The textual phrase is compared against a database of phrases previously identified as being problematic phrases. If the textual phrase matches a phrase in the database, the user is alerted via an in-line notification, based on the detected context of the electronic document.

### CROSS-REFERENCE TO RELATED APPLICATIONS

This application claims priority to Indian Provisional Application No. 2996/CHE/2011, filed Aug. 30, 2011, which is incorporated by reference herein in its entirety.

### BACKGROUND

Electronic communication is now the primary way most business employees communicate with one another. Text documents, spreadsheets, presentations, and electronic mail (e-mail) allow users to communicate and collaborate without the delay imposed by traditional paper-based communication. However, e-mails and other communications between employees can implicate potential violations of company policy or local, state or federal law that can go unchecked by attorneys or other legal personnel.

### BRIEF SUMMARY

It is in the best interest of companies to prevent violations of company policy or laws before they occur. As businesses glow, the number of documents in a business rises exponentially, and the potential that a particular document may implicate a violation of law or company policy grows. Business employees often knowingly or unknowingly discuss actions that could potentially lead to violations of company policy, such as a confidentiality policy, or run afoul of the law.

In accordance with one aspect of the invention, text created by a user in a document is captured and compared against a database of phrases previously identified as problematic phrases. If a match between a phrase in the document and a phrase in the database is found, the user is alerted via an in-line notification.

In accordance with another aspect of the invention, the notification includes one of underlining or highlighting the textual phrase.

In accordance with yet another aspect of the invention, the underlining or highlighting acts as a hyperlink directing the user to a document detailing the potential violation and suggesting other language to use in the alternative.

In another embodiment of the invention, the user can initiate a policy violation check of his or her document by selecting an instruction in the software where the document is being created.

In accordance with one embodiment of the invention, a system may include a database of phrases previously identified as problematic phrases. The system compares textual phrases present in a document to the database of problematic phrases. If a match occurs, the system alerts a user via an in-line notification.

In accordance with another aspect of the invention, a set of documents is analyzed to determine the frequency of a particular phrase. The phrase is then added to a database of potentially problematic phrases.

In accordance with another aspect of the invention, a set of documents is analyzed to determine characteristics of text in a set of documents. The software may use machine learning techniques to automatically add to a database of potentially problematic phrases.

Further embodiments, features, and advantages of the invention, as well as the structure and operation of the various embodiments of the invention are described in detail below with reference to accompanying drawings.

### BRIEF DESCRIPTION OF THE DRAWINGS/FIGURES

FIG. 1 is a flow diagram of a method for identifying problematic phrases in a document in accordance with one embodiment of the invention.

FIG. 2 is a sample policy page in accordance with an embodiment of the invention.

FIG. 3 is a sample database schema for the database of phrases in accordance with an embodiment of the invention.

FIG. 4 is an illustration of an embodiment of the invention.

FIG. 5 is a diagram of a policy violation checker according to an embodiment of the present invention.

FIG. 6 a flow diagram of a method of checking a document for problematic phrases before changes can be committed in accordance with an embodiment of the invention.

FIG. 7 is a diagram of an exemplary implementation of the invention.

FIG. 8 is a flow diagram of a method for updating a policy violation checker database according to an embodiment of the present invention.

FIG. 9 is a flow diagram of a method for updating a policy violation checker database according to a further embodiment of the present invention.

FIG. 10 is a diagram of an example computer system that can be used to implement an embodiment of the present invention.

### DETAILED DESCRIPTION

In the detailed description of embodiments that follows, references to “one embodiment”, “an embodiment”, “an example embodiment”, etc., indicate that the embodiment described may include a particular feature, structure, or characteristic, but every embodiment may not necessarily include the particular feature, structure, or characteristic. Moreover, such phrases are not necessarily referring to the same embodiment Further, when a particular feature, structure, or characteristic is described in connection with an embodiment, it is submitted that it is within the knowledge of one skilled in the art to effect such feature, structure, or characteristic in connection with other embodiments whether or not explicitly described.

While the present invention is described herein with reference to the illustrative embodiments for particular applications, it should be understood that the invention is not limited thereto. Those skilled in the art with access to the teachings provided herein will recognize additional modifications, applications, and embodiments within the scope thereof and additional fields in which the invention would be of significant utility.

Embodiments relate to methods and systems of detecting potential violations of company policy or evidence of legal violations in electronic documents.

When a user is creating an electronic document, such as a text document, spreadsheet, presentation, or electronic mail message, various phrases contained in the document can potentially legal liability for the user or user's employer, or give rise to policy violations if the document becomes public. Additionally, these documents may be used as evidence in court, administrative, or other proceedings. It is in a company's best interest to minimize or eliminate policy violations and/or situations that could give rise to legal liability. It is also often in a company's best interest to be able to Pack these situations. Problematic phrases include, but are not limited to, phrases that present policy violations, have legal implications, or are otherwise troublesome to a company, business, or individual.

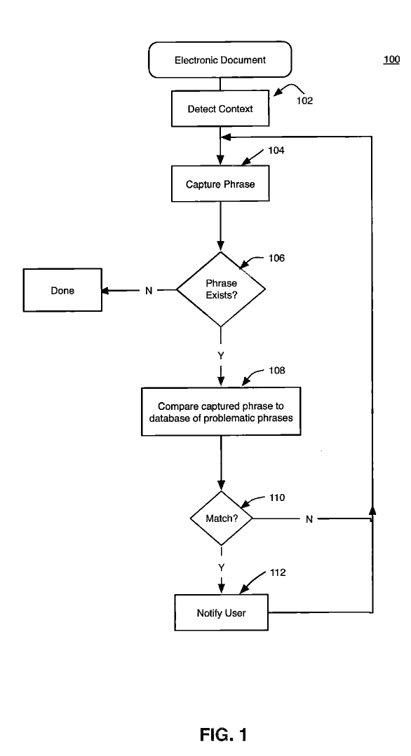

FIG. 1 illustrates a method 100 for checking a document for problematic phrases, according to an embodiment. In block 102, the context of the electronic document is detected. The context of a document may include many factors. For example, the context of the document may depend on the file format of the document, such as whether the document is an e-mail, a word processing document, a spreadsheet, a webpage, or any other type of electronic document. The context of the document may also depend on the intended recipient of the document. For example, the detected context of an e-mail intended for a colleague may be different than the detected context of an e-mail intended to be sent to an outside customer. The context of a document may also be detected based on the tone, grammar, or other features of the text in the document. For example, linguistic analysis may identify a document as informal due to slang usage or intentional misspellings.

In block 104, a phrase contained in an electronic document is captured. The length of the phrase may be, for example, at least one word. A phrase may include a word, an abbreviation, an acronym or other combination of characters. A phrase may be captured as a document is being created or after a document has been created. In block 106, if the document does not or no longer contains any unchecked phrases, the policy checker method is complete. If an unchecked phrase does exist, the method moves to block 108.

In block 108, a captured phrase is compared to a previously existing database of problematic phrases. In an embodiment, the database may be initially populated, for example and without limitation, by a member of a company's legal department, other employees, or outside consultants.

In an embodiment, the database contains one or more phrases, strings, or combinations of words that present legal implications and/or evidence policy violations. For example, a phrase in a document containing the words “project ABC is going to totally KILL company XYZ” could potentially give rise to an unfair competition claim. Similarly, a user may send an e-mail to a colleague stating “I will blog about our upcoming product,” which may violate a company's confidentiality policy. In these examples, the database may contain the phrases “totally kill” and “upcoming product.” These examples are not meant to be limiting in any way, but merely to serve as examples of the entries in the database.

In one embodiment, the database may be stored on a central server connected to a network. In another embodiment, the database may reside on an employee's individual device, such as, but not limited to, a computer, workstation, distributed computing system, embedded system, stand-alone electronic device, networked device, mobile device, set-top box, television, or other type of processor or computer system. In yet another embodiment, a primary database may be stored on a central server and periodically distributed or pushed out to an individual employee's device. In an embodiment the database can be periodically updated manually by a designated user. In this way, future iterations of method 100 may match additional phrases.

If the policy violation checker database is stored on an individual user device, the database can be periodically updated by sending an update file to a user device from a specific device, for example, from a computer in the legal department. In yet a further embodiment, an individual user device can perform the policy violation checking function, and the user device may receive the database of problematic phrases from a server controlled by the legal or compliance department.

A captured phrase and a phrase in the database can be compared using regular expressions or other technologies that will be apparent to those skilled in the art. For example and without limitation, the comparison of phrases may be based on one-to-one matching, a string similarity threshold, a checksum, fuzzy string searching, or other methods known in the art to match strings to one another.

In block 110, it is determined whether a match exists between the captured text in the document and an entry in the database. If a match exists, method 100 proceeds to block 112.

At block 112, depending on the context of the document, the user is notified. For example, the user may be presented with an in-line notification of a potential legal implication or policy violation at block 112. In one embodiment of the invention, notifications are presented only if an exact match occurs. For example, if the phrase “upcoming product” is present in the database, only documents containing that exact phrase will receive an in-line notification.

As stated above, the context of the document being checked for policy or other violations may determine whether a user is notified of a potential violation. For example, the context of the document may be detected as an informal e-mail between two co-workers. In this case, the user creating the document may not be alerted to certain potential violations. Similarly, the context of the document may be detected as a memorandum or a presentation intended for a third party outside the user's company. In this case, the user may be notified to a greater number of potential violations, to ensure that the document does not contain any potential violations before it is seen by a third-party. Additionally, the detected context of a document identifying the document as a potentially legally privileged document may determine whether it is checked for certain policy violations.

In an embodiment, notifications may be displayed even if the match is not exact. For example, if “totally kill” is present in the database, documents containing similar language, such as “totally destroy” or “totally take out” may receive notifications. Other regular expressions or technologies may be used to identify problematic phrases. For example, a match of the above phrase “upcoming product” may be identified where the word “upcoming” or variations thereof occur in the vicinity of the word “product.”

If no match occurs at block 110, the method returns to block 104 and repeats the method until all phrases are checked.

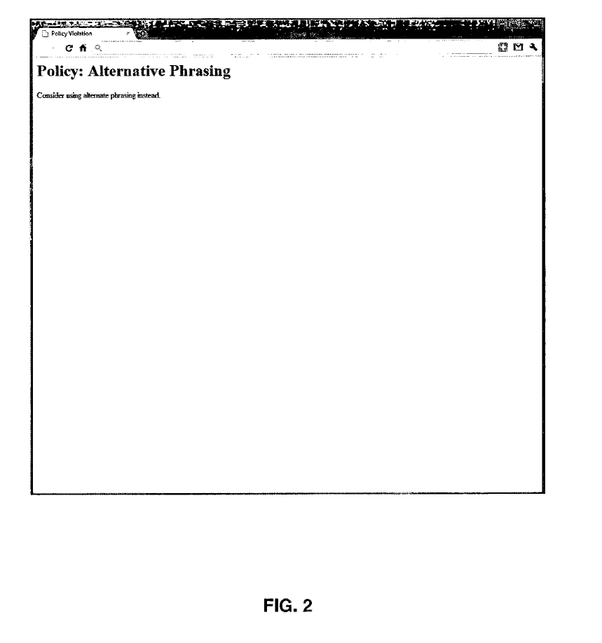

If a problematic phrase is identified at block 110, a notification of a phrase containing a potential violation of policy or having a legal implication is presented to the user at block 112. The notification may be, for example, an in-line notification. Such an in-line notification may include, but is not limited to, highlighting the problematic phrase or underlining the problematic phrase. The notification may serve to alert the user to a potential violation. In an embodiment, the notification may act as a hyperlink. The user can then select the notification to learn the potential ramifications of the problematic phrase. This may be done, for example, by sending the user to a webpage containing information about the particular policy that is applicable. The policy page may be viewed in an Internet browser. A sample policy page is shown in FIG. 2. The policy page may identify the reason the captured phrase is problematic, and/or suggest alternate language or actions for the user to take in order to reduce or eliminate the potential violation of policy or law. In another embodiment, the user may hover his mouse pointer over the highlighted or underlined phrase to display more information about the potential violation without needing to go to a separate document. In yet another embodiment, the user may be presented with a pop-up window that may display the applicable policy and other pertinent information.

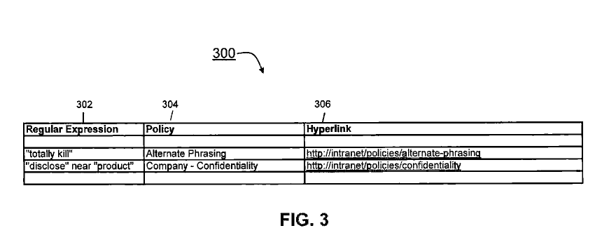

In an embodiment, each entry in the database of previously identified problematic phrases may contain multiple fields. FIG. 3 shows an example database schema 300 with sample entries, according to an embodiment. Regular expression column 302 contains the various words, phrases, regular expressions, or other text that may be matched in block 108. Policy column 304 lists the applicable policy to the identified regular expression. Hyperlink column 306 contains a hyperlink or other reference to a policy document applicable to the policy in policy column 304. The relationship between regular expression and policy may be one-to-one, one-to-many, many-to-one, or many-to-many. This example is not meant to limit the invention in any way. For example, the database may only contain two columns, such as the regular expression and the hyperlink, or it may contain more information than presented in FIG. 3.

In an embodiment, the database of previously identified problematic phrases may include a context column. The context column may identify when a user creating a document with the particular problematic phrase will be notified. For example, the context column may contain data such that a user writing an internal e-mail to a co-worker will not be notified if the regular expression “‘disclose’ near ‘product’” is matched, but that a user writing an e-mail to a third party with a match for the regular expression will be notified.

In one embodiment, a document being created by a user is checked for problematic phrases as it is being created. As a problematic phrase is identified, a notification appears to notify the user of the existence of a problematic phrase. For example, as the user finishes a sentence, the system may perform a policy violation check on the phrases in the completed sentence in the background to alert the user of a problematic phrase. This allows the user to nearly immediately be aware of a potential violation of policy or law while the text is fresh in the user's mind.

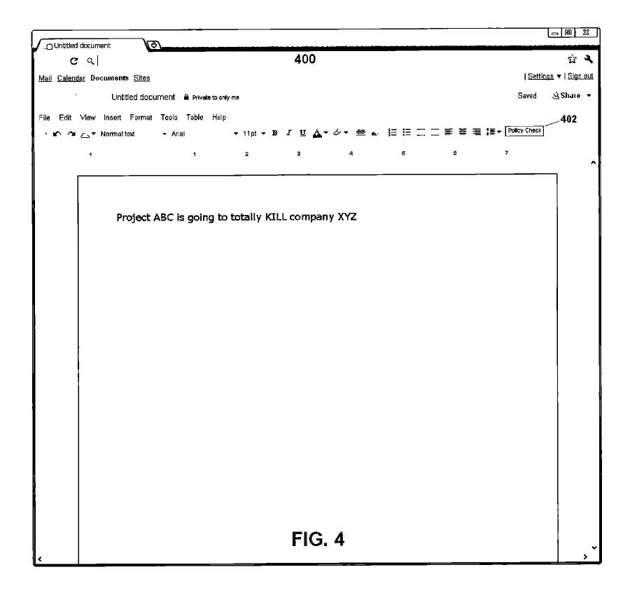

In an embodiment, the user can initiate a policy violation check of the document at any time by selecting an instruction in the word processing, e-mail, or other software being used. An instruction may include, for example and without limitation, a button, an icon, a link, or a menu item. Word processing software or e-mail software may include this capability. For example, as shown in FIG. 4, if a user is utilizing word processing software, a user may select an instruction 402, which will initiate the policy checker module or system and notify the user of any problematic phrases.

After the first phrase is checked, the process of FIG. 1 may repeat with the next phrase. The process detailed in FIG. 1 can be run for varied phrase lengths, depending on the user's desired configuration. For example, a company may choose to search phrases that range in length from one to fifteen words. This example is not meant to limit the invention in any way. In this way, the entire document is checked for potential policy violations or violations of law.

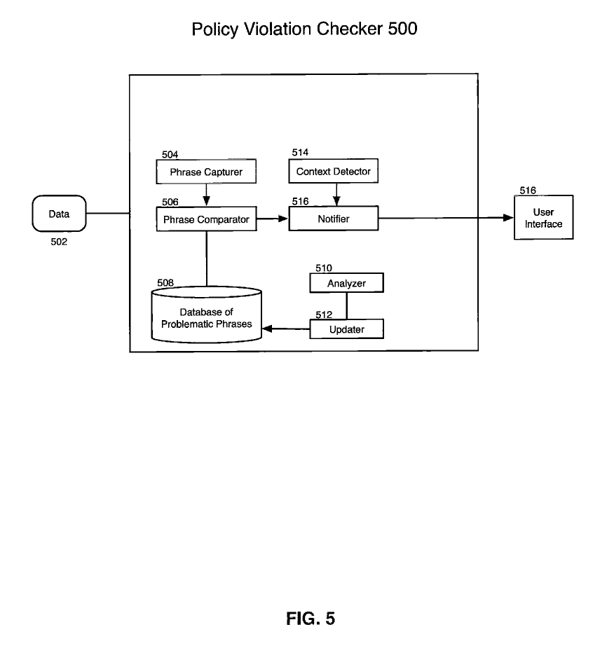

FIG. 5 shows a policy violation checker 500 according to an embodiment. Policy violation checker 500 includes a phrase capturer 504, phrase comparator 506, a database of identified potentially problematic phrases 508, analyzer 510, updated 512, context detector 514 and notifier 516.

Policy violation checker 500 may execute method 100 identified in FIG. 1 and further explained above, but is not limited and may operate in accordance with other embodiments.

In the embodiment shown in FIG. 5, policy violation checker 500 receives text or data 502. Data 502 can include, for example and without limitation, text from word processing software, e-mail software, spreadsheet software, or presentation software.

Phrase capturer 504 captures a phrase from data 502. The length may be, for example and without limitation, at least one word, depending on the configuration of phrase capturer 504.

Phrase comparator 506 uses regular expressions or similar known methods to compare an captured phrase from phrase capturer 504 with a database of problematic phrases contained in database 508. The phrase comparator may use regular expressions or other technologies that will be apparent to those skilled in the art. For example, the comparison of phrases may be based on one-to-one matching, a string similarity threshold, a checksum, fuzzy string searching, or other methods known in the art to match strings to one another.

Database 508 may be located in the same system as phrase capturer 504 and phrase comparator 506. Database 508 also may be coupled to phrase comparator 506 via a network, including but not limited to a local area network, medium area network, wide area network, or the Internet.

Notifier 516 may notify the user of a problematic phrase as described with respect to block 110 of FIG. 1, for example by sending output to user interface 518.

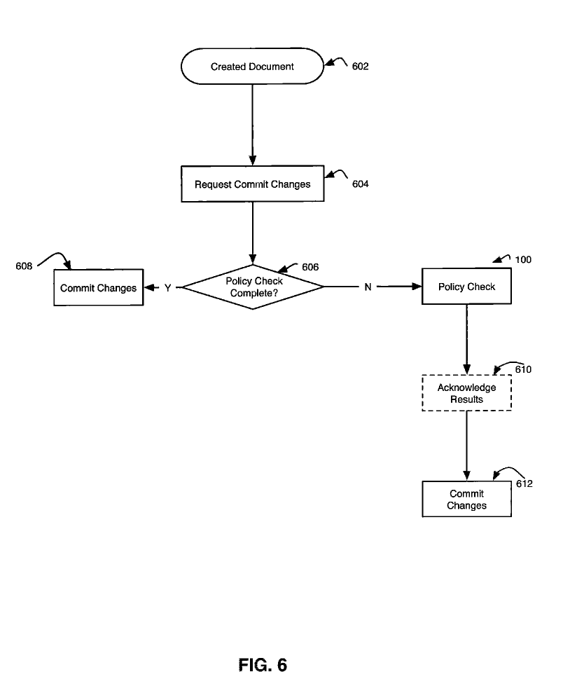

FIG. 6 is a flowchart of a method for checking a document for problematic phrases before changes can be committed, in accordance with an embodiment. In this embodiment, before the user is permitted to commit changes to a document, for example saving a document or sending an e-mail, the system may initiate a policy violation check and alert the user to problematic phrases contained in the document. In block 604, a user attempts to commit changes to a created document 602. In block 606, the system determines whether the document has previously been checked for problematic phrases, for example, by the user's action of selecting the policy check instruction 402 of FIG. 4. If the document has been checked, the user continues to block 508 and is permitted to commit changes to the document. If the document has not been checked, the document is checked for problematic phrases in block 100, as described with respect to FIG. 1 and method 100. Method 100 proceeds as detailed above, and the user is notified of any problematic phrases. Optionally, the user may be required to acknowledge that he has read the applicable policy or policies in block 610. After acknowledgement in block 610 or appropriate notifications in block 100, the user may then commit changes to the document in block 612. In an embodiment, if multiple problematic phrases are found, a custom document detailing all potential violations and suggestions is displayed for the user at the end of the policy violation check process or at the notification process.

In an embodiment, a designated third party can receive a notification of a potential policy violation as evidenced by a problematic phrase as it occurs. For example, if a user sends an e-mail with a problematic phrase even after receiving a notification and reading the applicable policy document, a member of the legal department may be notified of the e-mail and take appropriate action, such as logging the communication or speaking directly with the user. Similarly, if a user creates a text document, presentation, or other document with a problematic phrase, the policy violation checker may notify a member of the legal department of the existence of the document.

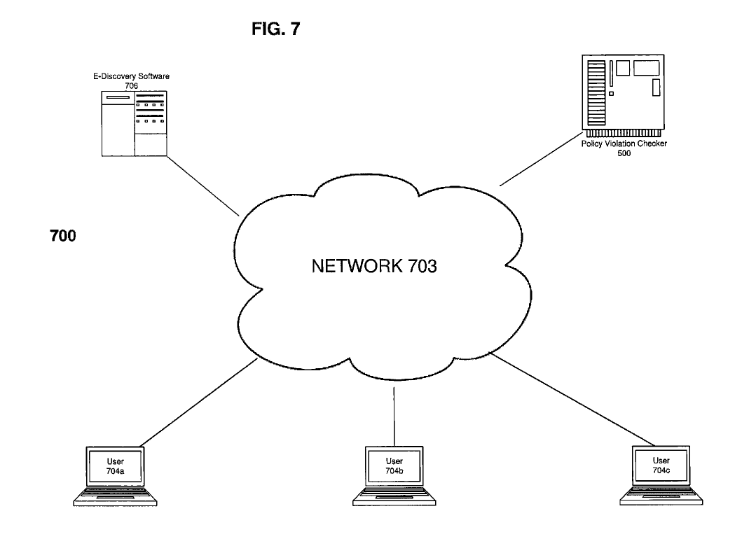

In an embodiment shown in FIG. 7, the policy violation checker 500 may be implemented on a standalone device connected to a network 702, including but not limited to a local area network, medium area network, or wide area network such as the Internet. In this embodiment, multiple users 704a, 704b, 704c, may use the functionality provided by the policy violation checker. The policy violation checker 500 may also be implemented as part of another networked device.

Alternatively, the policy violation checker may be implemented in software, firmware, or hardware, or any combination thereof, on a user's individual device.

The policy violation checker can be designed to suit the particular specifications of the company or user. For example, a company can specify that the policy violation checker only check phrases of a specific length, such as three or more words. The policy violation checker may also allow for certain tolerances. For example, the policy violation checker may notify a user of a problematic phrase when there is a percentage match, such as a 95% match.

In an embodiment, the database of problematic phrases can be created or updated by electronic discovery software that analyzes documents to determine additional problematic phrases.

Electronic discovery software is increasing in popularity. These software packages allow companies and law firms to analyze large numbers of documents to determine their relevancy to a particular legal matter. Documents are reviewed by attorneys, other legal personnel, or analyzed by computer for relevancy. Often, these software packages enable users to view statistics on a set of documents, such as frequency of a particular word or phrase in a set of documents.

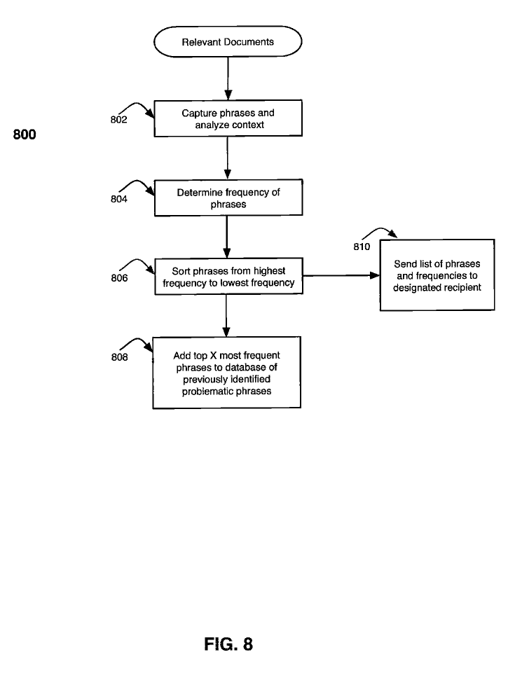

For example, a company's legal department may have identified 1,000 documents in a particular case that are relevant. Of those 1,000 documents, 75% may contain the phrase “upcoming product.” In an embodiment, this percentage may be automatically determined and satisfy a threshold identifying the phrase as problematic. The database of problematic phrases may then be updated automatically to include the phrase “upcoming product.” Such a method is illustrated in FIG. 8.

FIG. 8 illustrates an exemplary method 800 for adding phrases to a database of potentially problematic phrases based on a set of relevant documents, according to an embodiment. At the start of method 800, a number of relevant documents are provided. The documents provided may be representative of one context, or may represent various contexts. At block 802, the text of relevant documents is analyzed and words or phrases are captured. The context of relevant documents is also analyzed. In an embodiment, the length of a captured phrase may be at least one word. The method may be performed for multiple phrase lengths and is not limited to one particular length. Each document may be associated with a context. In block 804 and 806, the frequency of a particular phrase is determined, and the frequency of all phrases is sorted from highest to lowest. In an embodiment, as in block 808, the most frequent phrase or phrases may be automatically added to the database of problematic phrases. Each phrase added to the database may have an associated context for the phrase. Communication with the policy violation checker database may occur using Structured Query Language (SQL) or another similar database language, which will be apparent to one of skill in the art. In an embodiment, in block 810, the list of phrases, frequencies, and contexts may be sent to a specified user, for example a member of the legal department, to determine which phrases should be added to the database of problematic phrases. In an embodiment, policy violation checker 500 as described with respect to FIG. 5 includes an analyzer 510 and an updater 512 that may execute method 800 in accordance with the above description to add phrases to the database of problematic phrases 508.

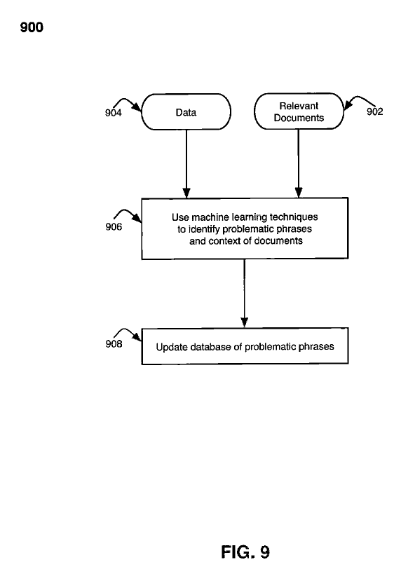

In an embodiment, electronic discovery software may be trained using machine learning techniques to identify problematic phrases without human intervention. For example, the electronic discovery software may use association rule learning. FIG. 9 illustrates an exemplary method 900 for adding phrases to a database of potentially problematic phrases using machine learning, according to an embodiment. In this example, data indicating that a set of documents is relevant to a confidentiality policy matter 902 is provided, along with a list of single words that may be indicative of problematic phrases 904. In block 906, machine learning techniques, such as association rule learning, are used to identify phrases that are potentially problematic. The machine learning techniques may also identify the context of documents containing potentially problematic phrases. In block 908, the database of problematic phrases is created or updated with the identified problematic phrases and contexts. In this example, the words “leak,” “divulge,” and “reveal” may be provided along with a set of documents that have been identified as relevant to the matter. Each document in the set may have a particular context associated with it. Phrases in the set of documents such as “leaking the news,” “divulge to media,” or “reveal the product” that are indicative of a potential confidentiality violation may be identified. These phrases can then be added to the policy violation checker database as described above. In an embodiment, only data indicating that a set of documents is relevant to a particular matter 902 is provided, and machine learning techniques are used to identify phrases that are potentially problematic in block 906. Various other machine learning techniques that may be used will be apparent to one of skill in the art. In an embodiment, policy violation checker 500 as described with respect to FIG. 5 includes an analyzer 510 and an updater 512 that may execute method 900 in accordance with the above description to add phrases to the database of problematic phrases 508.

The policy violation checker and electronic discovery software described herein can be implemented in software, firmware, hardware, or any combination thereof. The policy violation checker and electronic discovery software can be implemented to run on any type of processing device including, but not limited to, a computer, workstation, distributed computing system, embedded system, stand-alone electronic device, networked device, mobile device, set-top box, television, or other type of processor or computer system.

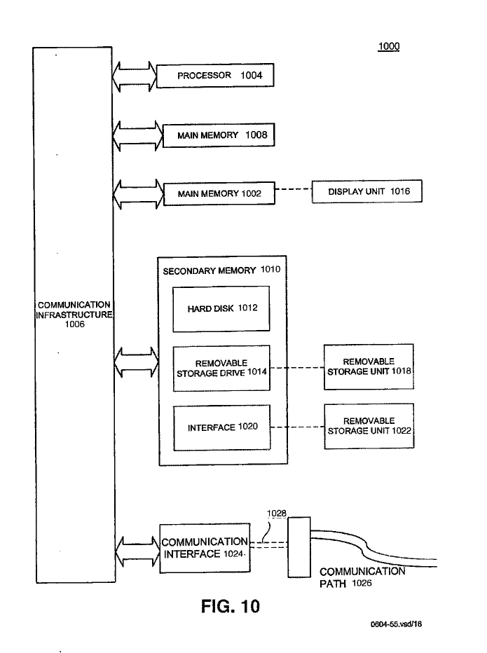

Various aspects of the present invention can be implemented by software, firmware, hardware, or a combination thereof. FIG. 10 illustrates an example computer system 1000 in which the embodiments, or portions thereof, can be implemented as computer-readable code. For example, policy violation checker 500 carrying out method 100 of FIG. 1 and/or method 800 of FIG. 8 can be implemented in system 1000. Various embodiments of the invention are described in terms of this example computer system 1000.

Computer system 1000 includes one or more processors, such as processor 1004. Processor can be a special purpose or a general purpose processor. Processor 1004 is connected to a communication infrastructure 1006 (for example, a bus or network).

Computer system 1000 also includes a main memory 1008, preferably random access memory (RAM), and may also include a secondary memory 1010. Secondary memory 1010 may include, for example, a hard disk drive and/or a removable storage drive. Removable storage drive 1014 may include a floppy disk drive, a magnetic tape drive, an optical disk drive, a flash memory, or the like. The removable storage drive 1014 reads from and/or writes to removable storage unit 1018 in a well known manner. Removable storage unit 1018 may include a floppy disk, magnetic tape, optical disk, etc. which is read by and written to by removable storage drive 1014. As will be appreciated by persons skilled in the relevant art(s), removable storage unit 1018 includes a computer usable storage medium having stored therein computer software and/or data.

In alternative implementations, secondary memory 1010 may include other similar means for allowing computer programs or other instructions to be loaded into computer system 1000. Such means may include, for example, a removable storage unit 1022 and an interface 1020. Examples of such means may include a program cartridge and cartridge interface (such as that found in video game devices), a removable memory chip (such as an EPROM, or PROM) and associated socket, and other removable storage units 1022 and interfaces 1020 which allow software and data to be transferred from the removable storage unit 1022 to computer system 1000.

Computer system 1000 may also include a communications interface 1024. Communications interface 1024 allows software and data to be transferred between computer system 1000 and external devices. Communications interface 1024 may include a modem, a network interface (such as an Ethernet card), a communications port, a PCMCIA slot and card, or the like. Software and data transferred via communications interface 1024 are in the form of signals which may be electronic, electromagnetic, optical, or other signals capable of being received by communications interface 1024. These signals are provided to communications interface 1024 via a communications path 1026. Communications path 1026 carries signals and may be implemented using wire or cable, fiber optics, a phone line, a cellular phone link, an RF link or other communications channels.

In this document, the terms “computer program medium” and “computer usable medium” are used to generally refer to media such as removable storage unit 1018, removable storage unit 1022, and a hard disk installed in hard disk drive 1012. Computer program medium and computer usable medium can also refer to one or more memories, such as main memory 1008 and secondary memory 1010, which can be memory semiconductors (e.g. DRAMs, etc.). These computer program products are means for providing software to computer system 1000.

Computer programs (also called computer control logic) are stored in main memory 1008 and/or secondary memory 1010. Computer programs may also be received via communications interface 1024. Such computer programs, when executed, enable computer system 1000 to implement the embodiments as discussed herein. In particular, the computer programs, when executed, enable processor 1004 to implement the processes of embodiments of the present invention, such as the steps in the methods discussed above. Accordingly, such computer programs represent controllers of the computer system 1000. Where embodiments are implemented using software, the software may be stored in a computer program product and loaded into computer system 1000 using removable storage drive 1014, interface 1020, or hard drive 1012.

In an embodiment, the database of problematic phrases may reside on primary storage 1008, secondary storage 1010, or may reside on other storage connected via communications interface 1024.

Embodiments may also be directed to computer products comprising software stored on any computer usable medium. Such software, when executed in one or more data processing device, causes a data processing device(s) to operate as described herein.

The summary and abstract sections may set forth one or more but not all exemplary embodiments of the present invention as contemplated by the inventor(s), and thus, are not intended to limit the present invention and the appended claims in any way.

Embodiments of the present invention have been described above with the aid of functional building blocks illustrating the implementation of specified functions and relationships thereof. The boundaries of these functional building blocks have been arbitrarily defined herein for the convenience of the description. Alternate boundaries can be defined so long as the specified functions and relationships thereof are appropriately performed. The breadth and scope of the present invention should not be limited by any of the above-described exemplary embodiments.

The foregoing description of the specific embodiments will so fully reveal the general nature of the invention that others can, by applying knowledge within the skill of the art, readily modify and/or adapt for various applications such specific embodiments, without undue experimentation, without departing from the general concept of the present invention. Therefore, such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

What is claimed is:

1. A method of identifying problematic phrases in an electronic document, comprising:
detecting a context of the electronic document;
capturing a textual phrase entered by a user;
comparing the textual phrase against a database of phrases previously identified as having legal implications or violating policy; and
alerting the user via an in-line notification when the textual phrase matches a phrase in the database having legal implications or violating policy, based on the detected context of the electronic document.

2. The method of claim 1, wherein the detected context is based on one or more of a file format of the document, a recipient of the document, a grammar of the document, or a potential legal privilege of the document.

3. The method of claim 1, wherein alerting the user comprises at least one of underlining or highlighting the textual phrase.

4. The method of claim 1, wherein the in-line notification further comprises a hyperlink to a webpage.

5. The method of claim 1, wherein comparing textual phrases occurs before changes can be committed to a document.

6. The method of claim 1, further comprising alerting a third party to a match between a textual phrase and a phrase in the database having legal implications or violating policy.

7. The method of claim 1, wherein the comparing and alerting take place as the document is being created.

8. The method of claim 1, wherein a match includes phrases having less than 100% similarity.

9. The method of claim 1, further comprising:
analyzing a set of electronic documents identified as having legal implications or violating policy;
determining a frequency of a particular phrase in the set of electronic documents; and
adding the particular phrase to the database of potentially problematic phrases.

10. The method of claim 9, further comprising determining a context of the particular phrase.

11. The method of claim 1, further comprising:
analyzing a set of electronic documents;
using machine learning techniques, determining characteristics of a problematic phrase in the set of electronic documents; and
adding one or more phrases identified by the machine learning techniques to the database of potentially problematic phrases.

12. The method of claim 11, wherein the characteristics include a context of the problematic phrase.

13. A policy violation checker for identifying problematic phrases in an electronic document, comprising:
a database of phrases previously identified as problematic phrases;
a context detector that detects a context of the electronic document;
a phrase comparator that compares an entered textual phrase to the database of problematic phrases; and
a notifier that alerts a user via an in-line notification when the phrase comparator identifies an entered textual phrase as matching a phrase in the database, based on the identified context of the electronic document.

14. The policy violation checker of claim 13, wherein the in-line notification comprises at least one of underlining or highlighting the textual phrase.

15. The policy violation checker of claim 13, wherein the notifier further alerts a third party to an identified match.

16. The policy violation checker of claim 13, further comprising:
an analyzer to determine the frequency of a string or phrase in a set of documents identified as relevant; and
an updater to add one or more most frequently found phrases to the database of problematic phrases.

17. A computer readable storage medium having instructions stored thereon that, when executed by a processor, cause the processor to perform operations including:
detecting a context of an electronic document;
capturing a textual phrase entered by a user;
comparing the textual phrase against a database of phrases previously identified as problematic phrases; and
alerting the user via an in-line notification when the textual phrase matches a phrase in the database, based on the detected context.

18. The computer readable storage medium of claim 17, wherein the detected context is based on one or more of a file format of the document, a recipient of the document, a grammar of the document, or a potential legal privilege of the document.

19. The computer readable storage medium of claim 17, wherein alerting the user comprises at least one of underlining or highlighting the textual phrase.

20. The computer readable storage medium of claim 17, wherein the in-line notification further comprises a hyperlink to a webpage.

21. The computer readable storage medium of claim 17, wherein comparing textual phrases occurs before changes can be committed to a document.

22. The computer readable storage medium of claim 17, further comprising instructions that, when executed, cause the one or more processors to alert a third party to a match between a textual phrase and a phrase in the database.

23. The computer readable storage medium of claim 17, wherein the comparing and alerting take place as the document is being created.

24. The computer readable storage medium of claim 17, wherein a match includes phrases having less than 100% similarity.

25. The computer readable storage medium of claim 17, further comprising instructions that, when executed, cause the one or more processors to:
analyze a set of electronic documents;
determine a frequency of a particular phrase in the set of electronic documents; and
add the phrase to a database of potentially problematic phrases.

26. The computer readable storage medium of claim 25, further comprising instructions that, when executed, cause the one or more processors to determine a context of the particular phrase.

27. The computer readable storage medium of claim 17, further comprising instructions that, when executed, cause the one or more processors to:
analyze a set of electronic documents identified as having legal implications or violating policy;
using machine learning techniques, determine characteristics of a problematic phrase in the set of electronic documents; and
add one or more phrases identified by the machine learning techniques to the database of potentially problematic phrases.

28. The computer readable storage medium of claim 27, wherein the characteristics include a context of the problematic phrase.
